(19) United States
(12) Patent Application Publication
(10) Pub. No.: US 2025/0334211 A1
(43) Pub. Date: Oct. 30, 2025

(54) CONDUIT FEED-THROUGH, USE OF A CONDUIT FEED-THROUGH AND METHOD FOR ASSEMBLING A CONDUIT FEED-THROUGH

(71) Applicant: PFLITSCH GMBH & CO. KG, Hückeswagen (DE)

(72) Inventor: Martin LECHNER, Lindlar (DE)

(73) Assignee: PFLITSCH GMBH & CO. KG, Hückeswagen (DE)

(21) Appl. No.: 19/264,236

(22) Filed: Jul. 9, 2025

Related U.S. Application Data
(63) Continuation of application No. PCT/EP2024/050874, filed on Jan. 16, 2024.

(30) Foreign Application Priority Data
Jan. 17, 2023 (DE) 102023101036.0

(51) Int. Cl. F16L 5/02; H02G 3/22

(52) U.S. Cl. CPC F16L 5/02; H02G 3/22

(57) ABSTRACT

A conduit feed-through includes at least one first frame part and at least one second frame part. The first frame part includes at least one base web and at least two vertical webs, and the second frame part can be arranged on the vertical webs to form at least one surrounding frame. At least one assembly aid is arranged between the at least two vertical webs, and the at least one assembly aid is joined by material to the base web and has at least one predetermined breaking point.

### CROSS-REFERENCE TO RELATED APPLICATIONS

This application is a continuation of International Application No. PCT/EP2024/050874, filed on Jan. 16, 2024, which claims priority to and the benefit of DE 102023101036.0 filed on Jan. 17, 2023. The disclosures of the above applications are incorporated herein by reference.

### FIELD

The present disclosure relates to a conduit feed-through, a use of a conduit feed-through, and a method for assembling a conduit feed-through.

### BACKGROUND

The statements in this section merely provide background information related to the present disclosure and may not constitute prior art.

Conduit feed-throughs for passing cables through a wall, for example, are generally known from the prior art. DE 10 2020 126 444 A1 discloses a conduit feed-through with a base frame and a plurality of conduit feed-through modules.

Prior conduit feed-throughs use assembly aids that must be used individually and removed again after the insert modules have been installed. When installed in the conduit feed-through, the insert modules are stabilized only by the vertical webs in the frame.

### SUMMARY

This section provides a general summary of the disclosure and is not a comprehensive disclosure of its full scope or all of its features.

The present disclosure provides an improved conduit feed-through, an improved use and an improved method. In particular, the present disclosure provides a conduit feed-through, a use and a method in which insert modules can be flexibly inserted into a frame and, in particular, have improved stability in the assembled frame.

The present disclosure provides a conduit feed-through comprising at least one first frame part and at least one second frame part as well as a number of insert modules, wherein the first frame part comprises at least one base web and at least two vertical webs, wherein the second frame part can be arranged on the vertical webs to form at least one surrounding frame, wherein at least one assembly aid is arranged between the at least two vertical webs, wherein the at least one assembly aid is material-connected to the base web and has at least one predetermined breaking point, wherein the assembly aids can be separated from the first frame part at the predetermined breaking point and removed, so that insert modules of different widths can be inserted into the conduit feed-through.

Furthermore, the present disclosure provides using a conduit feed-through described above for feeding cables through a wall.

Furthermore, the present disclosure provides a method for assembling a conduit feed-through described above, comprising the steps of providing a first frame part, a second frame part and a number of insert modules, inserting at least one insert module between two vertical webs of the first frame part or between a vertical web and an assembly aid of the first frame part or between two assembly aids of the first frame part, wherein at least one assembly aid is removed from the first frame part in advance at a predetermined breaking point if a spacing between a vertical web and an assembly aid or between two assembly aids is smaller than a nominal width of an insert module, and arranging the second frame part on the vertical webs of the first frame part.

A conduit feed-through comprising at least one first frame part and at least one second frame part as well as a number of insert modules is proposed. The first frame part comprises at least one base web and at least two vertical webs, wherein the second frame part can be arranged on the vertical webs to form at least one surrounding frame. At least one assembly aid is arranged between at least two vertical webs, wherein the at least one assembly aid is material-connected to the base web and has at least one predetermined breaking point, wherein the assembly aids can be separated from the first frame part at the predetermined breaking point and removed, so that insert modules of different widths can be inserted into the conduit feed-through.

As an advantage, the proposed conduit feed-through allows elongated parts, such as electrical cables, pneumatic hoses, hydraulic hoses and/or optical waveguides, to be introduced quickly, easily and, first of all, in a space-saving manner into, for example, switch cabinets, casings or machines. Insertion modules adapted to the elongated parts to be fed through are particularly advantageous and can be inserted into the cable feed-through. The assembly aid can be removed or broken out of the first frame part at the predetermined breaking point. The assembly aids can be separated from the first frame part at the predetermined breaking point and removed so that insert modules of different widths can be inserted into the cable feed-through. The assembly aids are joined by material and arranged on the base web in such a way that they cannot be lost. If desired, the assembly aids can be easily and preferably separated from the first frame part without tools or broken out at the predetermined breaking point. Furthermore, the assembly aids improve the stability of the assembled cable feed-through.

The conduit feed-through comprises a first frame part. The first frame part comprises a base web and at least two vertical webs. In one example, the first frame part comprises more than two, preferably three or four vertical webs. The vertical webs are preferably arranged parallel to one another. It is further preferably provided that the vertical webs are arranged on a first side of the base web. In one example, the vertical webs are arranged exactly on the first side of the base web. Preferably, the vertical webs each comprise a receiver for fastening elements. Preferably, the second frame part can be fastened to the vertical webs by means of the fastening elements. In addition, the fastening elements are preferably developed as screws, by means of which the second frame part can be screwed onto the vertical webs.

In a further example, the vertical webs comprise fastening holes. Preferably, the conduit feed-through can be fastened to a wall, for example a wall of a device housing, by means of fastening elements such as screws or rivets. The fastening elements are advantageously guided through the fastening holes in order to fasten the conduit feed-through to the wall. The vertical webs are advantageously designed in such a way that they form a completely surrounding frame together with the base web and the second frame part.

In a further example, two or more than two, preferably three to five, further preferably more than five vertical webs are arranged on the base web. The vertical webs advantageously support the second frame part.

The first frame part comprises at least one assembly aid. In one example, it is provided that about one to about five assembly aids are provided. In one example, it is provided that about one to about five assembly aids are provided between each two vertical webs.

If, in the sense of the present disclosure, the term “about” is used in connection with values or value ranges, this is to be understood as a tolerance range that is considered normal by a person skilled in the art; in particular, a tolerance range of ±20%, preferably ±10%, further preferably ±5% is provided.

In so far as different value ranges, for example preferred and further preferred value ranges, are specified in the present disclosure, the lower limits and the upper limits of the different value ranges can be combined with one another.

The at least one assembly aid is fastened to the base web in a material-connected manner. Material-connected in the sense of the present disclosure means that the assembly aid is connected to the base web in a substance-to-substance bonded manner. Preferably, the assembly aid is injection-molded or cast together with the base web in a single operation. The assembly aid may be made of the same or a different material as the base web. Preferably, the assembly aid comprises the same material as the base web and is in particular monolithically shaped. In a further example, the assembly aid comprises a material which differs from the material of the base web. In one example, at least the first frame part is manufactured in a multi-component injection molding process.

The assembly aid preferably comprises at least one guide section. In addition, the vertical webs preferably comprise at least one guide section in each case. The guide section is preferably a section of the assembly means which guides and/or holds at least one insert part when the conduit feed-through is being fitted. Preferably, an insert module can be inserted into the first frame part between two guide sections. In one example, at least one assembly aid is provided with a guide section which is directly adjacent to the base web. An insertion module can advantageously be guided flush with the base web by means of the guide section.

In one example, at least one assembly aid on the side facing away from the base web has at least one plug head for plug connection to the second frame part. The at least one plug head is designed, for example, as one or more pins, at least one pipe or a tapered section.

In one example, the assembly aid is provided without a plug-in head. Further preferably, the assembly aid does not comprise a plug-in connection with the second frame part. In one example, at least one assembly aid is arranged spaced apart from the second frame part. This advantageously achieves a saving in material. Furthermore, it is advantageous that the second frame part is easier to assemble on the first frame part, since only positioning elements of the second frame part need to be inserted into receivers of the vertical webs. This significantly speeds up the assembly of the cable feed-through.

The assembly aid comprises at least one predetermined breaking point. It is advantageous if the assembly aid is held in place on the first frame part in such a way that it cannot be lost. Furthermore, it is advantageous if the assembly aid can be solved at least partially from the first frame part without tools, should this be desired for assembling the first frame part with insert modules. In one example, it is provided that the predetermined breaking point of the assembly aids has a material weakening. Preferably, the predetermined breaking point comprises a single-sided or double-sided notch or material tapering. In a further example, the predetermined breaking point comprises a perforation. Advantageously, the assembly aid can be broken out of the first frame part at the predetermined breaking point. Further preferably, the assembly aid can be shortened at the predetermined breaking point.

For example, the assembly aids are arranged in the first frame part in such a way that there is a first spacing in each case between the vertical webs and an assembly aid and/or between two assembly aids. Advantageously, by means of a preferably tool-free removal of an assembly aid, a second spacing between a vertical web and an assembly aid, a spacing between two vertical webs or a spacing between two assembly aids can be created, which is preferably about twice as large as the first spacing. The removal of further assembly aids can preferably create further spacings.

In one example, the predetermined breaking point is provided directly adjacent to the base web. After removing the assembly aid at the predetermined breaking point, a break may remain on the base web. The break is preferably in the main plane with a first surface of the first side of the base web. In a further example, the predetermined breaking point is arranged at a place on the assembly aid spaced apart from the base web. For example, at least one predetermined breaking point is arranged approximately in the center of the assembly aid. In one example, the assembly aid comprises at least two predetermined breaking points. In this way, the assembly aid can be shortened and/or completely removed as desired, in particular without the use of tools.

The term “substantially” indicates a tolerance range which is acceptable to a person skilled in the art from an economic and technical point of view, so that the corresponding feature is still recognizable as such or is realized.

The conduit feed-through comprises at least a second frame part. As an advantage, the insert part or insert parts inserted in the first frame part can be held by means of the second frame part. The second frame part advantageously stabilizes the cable feed-through. It is advantageous for the second frame part to be arranged parallel to the first frame part on the vertical webs. Furthermore, it is preferable for the second frame part to be screwed onto the vertical webs. Fastening elements are preferably provided for arranging the second frame part on the vertical webs. The fastening elements are further preferably guided through receivers of the second frame part in order to screw the second frame part to the first frame part, for example. In one example, the second frame part comprises at least one plug head receiver, in particular for receiving at least one plug head of at least one assembly aid.

In one example, the second frame part has positioning elements that are preferably assignable to the receivers of the vertical webs. The positioning elements are preferably assigned to the receivers for the fastening elements. The positioning elements can advantageously facilitate installing, since they provide alignment of the receivers of the second frame part and the receivers of the vertical webs.

According to the present disclosure, it is provided that the latter has a number of insert modules. It is advantageous if the first frame part can be assembled with, for example, one to about ten insert modules. In one example, the conduit feed-through is designed as a set comprising at least the first and second frame parts and at least one insert module. The set may comprise a plurality of insert modules, preferably one insert module up to about 20 insert modules. In one example, the set comprises a plurality of insert modules which are in particular suitable for different applications. The set preferably comprises a number of insert modules, not all of which can be inserted into the first frame part at the same time. When assembling the first frame part with the insert modules, it is advantageous to be able to select from a variety of different insert modules in order to adapt the conduit feed-through to a specific application. The at least one insert module preferably comprises a rubber elastic material. Advantageously, at least one elongated part can be guided through the insert module. In one example, it is provided that the insert modules each have a number of elongated part receivers. In one example, it is provided that at least one insert module does not have elongated part receivers. Advantageously, an insert module without elongated part receivers can be used as a blind plug.

Insert modules of different widths can preferably be inserted into the first frame part. Insert modules with a first width between two assembly aids, one assembly aid and one vertical web or two vertical webs, which are spaced apart from each other, can preferably be inserted. Further preferably, insert modules with a second width can be inserted between two assembly aids, one assembly aid and one vertical web or two vertical webs, which have a second spacing from one another.

Preferably, at least one insert module is inserted into the first frame part. Further preferably, the first frame part is assembled with a plurality of insert modules. Preferably, the first frame part is assembled or can be assembled with insert modules in such a way that these fill an intermediate space between the base web and the second frame part substantially completely.

An exemplary conduit feed-through comprises a first frame part with a base web and three vertical webs arranged on a first side of the base web. Two assembly aids are arranged between a first vertical web and a second vertical web. A third assembly aid is arranged between the second vertical web and a third vertical web. A second frame part, which can be placed on the vertical webs, comprises receivers for fastening elements, which are formed as screws. The receivers are assigned positioning elements which can be inserted in each case into receivers on the end faces of the vertical webs. The receivers of the vertical webs each comprise internal screw threads into which the fastening elements can be screwed. The outer vertical webs, i.e. the first vertical web and the third vertical web, comprise, for example, fastening holes by means of which the first frame part or the conduit feed-through can be fastened to a wall, for example of a casing, for example by means of screws or rivets.

The at least one assembly aid is material-connected to the base web. The assembly aid comprises, for example, a guide section which is adjacent to the base web. Furthermore, the assembly aid comprises, for example, a plug head which is arranged on the side facing away from the base web. Plug heads of the assembly aids engage in plug head receivers of the second frame part. In addition, the assembly aid comprises a predetermined breaking point which is assigned, for example, directly to the base web. The predetermined breaking point is developed, for example, as a one-sided notch which weakens the material of the assembly aid in a defined manner so that the latter can be removed from the first frame part without tools.

Once the second frame part is assembled on the vertical bars of the first frame part, a surrounding frame is formed.

The predetermined breaking point, which is developed as an exemplary one-sided notch, is designed in such a way that it merges into the first side of the base web. The predetermined breaking point extends, for example, over approximately half the width of the assembly device so that the assembly device can be easily detached without tools.

The first frame part can be assembled with insert modules which are inserted between the vertical webs or the assembly aids. The insert modules are developed for different elongated parts. For example, some of the insert modules each comprise an elongated part receiver. Other elongated part receivers have different dimensions of the diameters of the elongated part receivers. Some insert modules comprise two elongated part receivers. Furthermore, some insert modules comprise more than two, for example three or four elongated part receivers. For example, some insert modules do not comprise any elongated part receivers or openings and can be used as blind plugs. The assembly aids simplify the exact positioning of the insert modules during assembly and, furthermore, offer the additional advantage of high stability when installed. For example, insert modules with different widths and/or heights can be inserted into the first frame part.

In a further example of the cable feed-through, it is provided that the assembly aids do not have a plug-in head which engages in the second frame part. The assembly aids extend close to the second frame part but do not touch it even when the second frame part is assembled on the first frame part. In particular, the assembly aid is spaced apart from the second frame part. Thanks to this example, the assembly aids do not need to be threaded exactly into plug-in receptacles of the second frame part, which greatly simplifies assembly.

Furthermore, the use of a conduit feed-through as described above for feeding cables through a wall is proposed. In particular, the conduit feed-through is used with a number of different insert modules.

Furthermore, a method for assembling a conduit feed-through described above, comprising the steps of providing a first frame part, a second frame part and a number of insert modules, inserting at least one insert module between two vertical webs of the first frame part or between a vertical web and an assembly aid of the first frame part or between two assembly aids of the first frame part, wherein at least one assembly aid is removed from the first frame part in advance at a predetermined breaking point if a spacing between a vertical web and an assembly aid or a spacing between two assembly aids is smaller than a nominal width of an insert module, and arranging the second frame part on the vertical webs of the first frame part.

In the sense of the present disclosure, a spacing between two assembly aids is smaller than a nominal width of an insert module if the spacing is at least about 5%, preferably at least about 10%, further preferably at least about 25%, further preferably at least about 25% to about 90%, further preferably about 25% to about 75% smaller than the nominal width of the insert module.

In one example, the insert module has a nominal width that is about 1% to about 5% greater than the spacing between a vertical web and an assembly aid or the spacing between two assembly aids. The insert module is preferably used under prestress between a vertical web and an assembly aid or the spacing between two assembly aids.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is an exploded perspective view of a conduit feed-through according to one form of the present disclosure;

FIG. 2 is a detail view of the conduit feed-through at II of FIG. 1;

FIG. 3 is a front view of the conduit feed-through of FIG. 1;

FIG. 4 is a detail view of the conduit feed-through at IV of FIG. 3;

FIG. 5 is a perspective view of the conduit feed-through from FIG. 1 assembled with insert modules;

FIG. 6 is an exploded perspective view of another form of the conduit feed-through according to the present disclosure;

FIG. 7 is a front view of the conduit feed-through of FIG. 6;

FIG. 8 is a detail view of the conduit feed-through at VIII of FIG. 7;

FIG. 9 is a perspective view of a first frame part of the conduit feed-through of FIG. 7 with assembly aids removed; and

FIG. 10 is a perspective view of the conduit feed-through of FIG. 9 assembled with insert modules.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

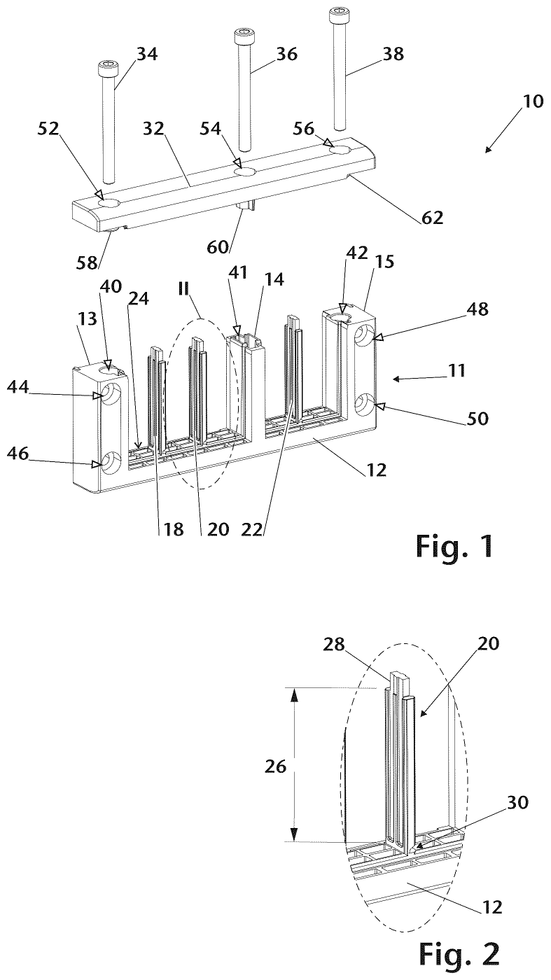

FIG. 1 shows a conduit feed-through 10 in an exploded view. The conduit feed-through 10 comprises a first frame part 11 with a base web 12 and three vertical webs 13, 14 and 15, which are arranged on a first side 24 of the base web 12. Two assembly aids 18 and 20 are arranged between the vertical webs 13 and 14. A further assembly aid 22 is arranged between the vertical webs 14 and 15. A second frame part 32, which can be placed on the vertical webs 13, 14 and 15, comprises receivers 52, 54 and 56 for fastening elements 34, 36 and 38, which are formed as screws. Positioning elements 58, 60, and 62 are assigned to receivers 52, 54, and 56, which can be inserted into receivers 40, 41, and 42 of vertical webs 13, 14, and 15. The receivers 40, 41 and 42 each comprise a non-visible internal screw thread into which the fastening elements 34, 36 and 38 can be screwed. The vertical webs 13 and 15 also comprise fastening holes 44, 46, 48, 50, by means of which the first frame part 11 or the conduit feed-through 10 can be fastened to a wall, for example by means of screws or rivets.

FIG. 2 shows in detail II of FIG. 1 the assembly aid 20. This is arranged material-connected on the base web 12. The assembly aid 20 comprises a guide section 26 which is adjacent to the base web 12. In addition, the assembly aid 20 comprises a plug-in head 28, which is arranged on the side facing away from the base web 12. The assembly aid 20 further comprises a predetermined breaking point 30, which is directly assigned to the base web 12. The predetermined breaking point 30 is developed as a one-sided notch which defines the material of the assembly aid 20 in such a way that it can be removed from the first frame part 11 without the need for tools.

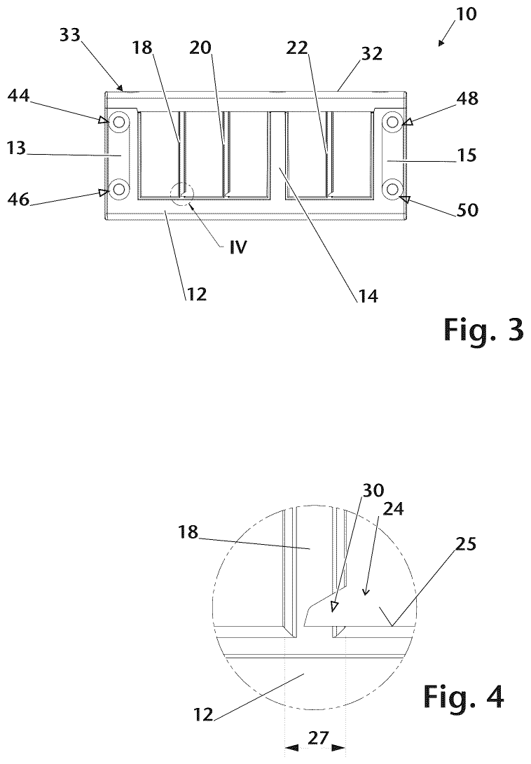

FIG. 3 shows the conduit feed-through from FIG. 1 in a front view. In this view, the second frame part 32 is assembled on the vertical webs 13, 14, and 15 so that a circumferential frame 33 is formed. Furthermore, FIG. 3 shows the assembly aids 18, 20 and 22, which are arranged between the vertical webs 13, 14 and 15. The plug heads of the assembly aids, which are not visible here, engage in plug head receivers of the second frame part 32, which are not visible here. Furthermore, the first frame part 11 comprises the fastening bores 44, 46, 48, and 50, which are arranged in the vertical webs 13 and 15.

FIG. 4 shows a detail IV from FIG. 3. In particular, a transition of the base web 12 into the assembly aid 18 is shown. The predetermined breaking point 30, which is developed as a one-sided notch, is designed in such a way that it merges flush into a surface 25 of the first side 24 of the base web 12. The predetermined breaking point 30 extends over about half of the width 27 of the assembly aid 18, so that the assembly aid 18 can be conveniently detached without tools.

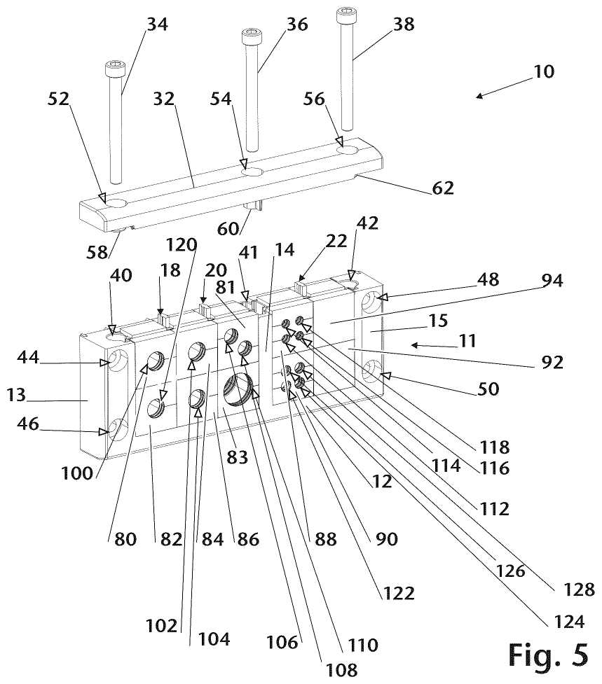

FIG. 5 shows the conduit feed-through 10 from FIG. 1 assembled with insert modules 80, 81, 82, 83, 84, 86, 88, 90, 92 and 94, which are inserted between the vertical webs 13, 14 and 15 and the assembly aids 18, 20 and 22, respectively. The insert modules 80, 81, 82, 83, 84, 86, 88, 90, 92 and 94 are developed for the passage of different elongated parts which are not shown in the figures. Thus, the insert modules 80, 82, 84, 86, and 83 each comprise an elongated part receiver 100, 120, 102, 104, and 110. The elongated part receiver 110 has different dimensions than the elongated part receivers 100, 120, 102, and 104. The insert module 81 comprises two elongated part receivers 106 and 108. Furthermore, the insert modules 88 and 90 each comprise four elongated part receivers 112, 114, 116, 118, 122, 124, 126 and 128. The insert modules 92 and 94 do not comprise any elongated part receivers or openings and are used, for example, as blind plugs. The assembly aids 18, 20, and 22 simplify the exact positioning of the insert modules 80, 81, 82, 83, 84, 86, 88, 90, 92, and 94 during assembly.

The second frame part 32, which can be placed on the vertical webs 13, 14, and 15, comprises receivers 52, 54, and 56 for fastening elements 34, 36, and 38, which are formed as screws. Positioning elements 58, 60 and 62 are assigned to the receivers 52, 54 and 56, which can be inserted into receivers 40, 41 and 42 of the vertical webs 13, 14 and 15. The receivers 40, 41, 42 each comprise a non-visible internal screw thread into which the fastening elements 34, 36 and 38 can be screwed. The vertical webs 13 and 15 also comprise fastening bores 44, 46, 48, 50, by means of which the first frame part 11 or the conduit feed-through 10 can be fastened to a wall, for example by means of screws or rivets.

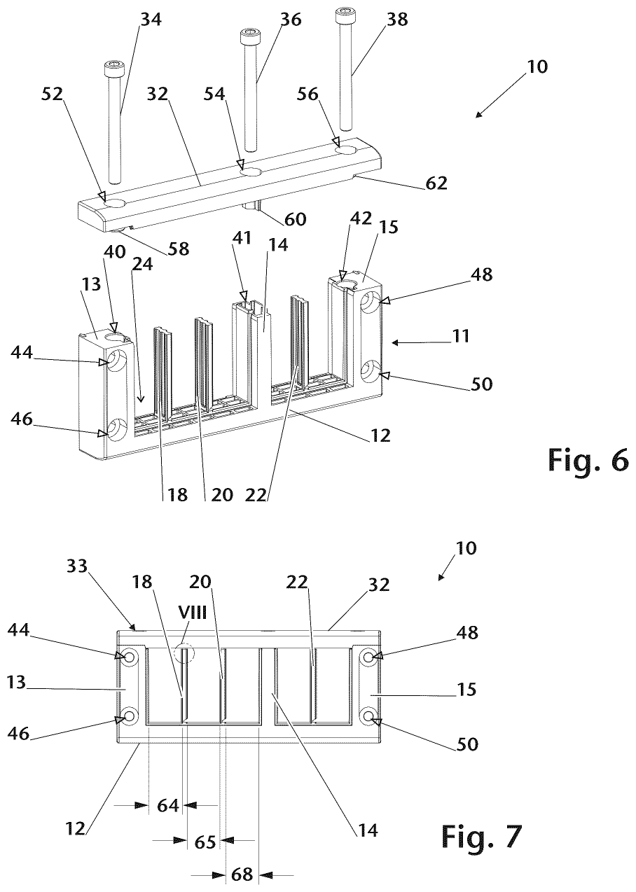

FIG. 6 shows a further example of the conduit feed-through in an exploded view. The conduit feed-through 10 comprises a first frame part 11 with a base web 12 and three vertical webs 13, 14 and 15, which are arranged on a first side 24 of the base web 12. Two assembly aids 18 and 20 are arranged between the vertical webs 13 and 14. A further assembly aid 22 is arranged between the vertical webs 14 and 15. In contrast to the previous example, the assembly aids 18, 20 and 22 do not have a plug-in head which engages in the second frame part 32.

A second frame part 32, which can be placed on the vertical webs 13, 14 and 15, comprises receivers 52, 54 and 56 for fastening elements 34, 36 and 38, which are formed as screws. Positioning elements 58, 60, and 62 are assigned to the receivers 52, 54, and 56, which can be inserted into receivers 40, 41, and 42 of the vertical webs 13, 14, and 15. The receivers 40, 41, 42 each comprise a non-visible internal screw thread into which the fastening elements 34, 36 and 38 can be screwed. The vertical webs 13 and 15 also comprise fastening holes 44, 46, 48, 50, by means of which the first frame part 11 or the conduit feed-through 10 can be fastened to a wall, for example by means of screws or rivets.

FIG. 7 shows a front view of the conduit feed-through from FIG. 6. The second frame part 32 is assembled on the vertical webs 13, 14, and 15 so that a circumferential frame 33 is formed. Furthermore, the assembly aids 18, 20 and 22 are arranged between the vertical webs 13, 14 and 15. There is a spacing 64 between the vertical web 13 and the assembly aid 18. There is also a spacing 65 between the assembly aid 18 and the assembly aid 20, which is about the same size as the spacing 64. There is a spacing 68 between the assembly aid 20 and the vertical web 14, which is about the same size as the spacing 64. The spacings 64, 65, and 68 are all referred to below as the first spacing, since they are about the same size. The assembly aids 18, 20 and 22 extend close to the second frame part. Furthermore, the first frame part 11 comprises the fastening holes 44, 46, 48 and 50, which are arranged continuously in the vertical webs 13 and 15.

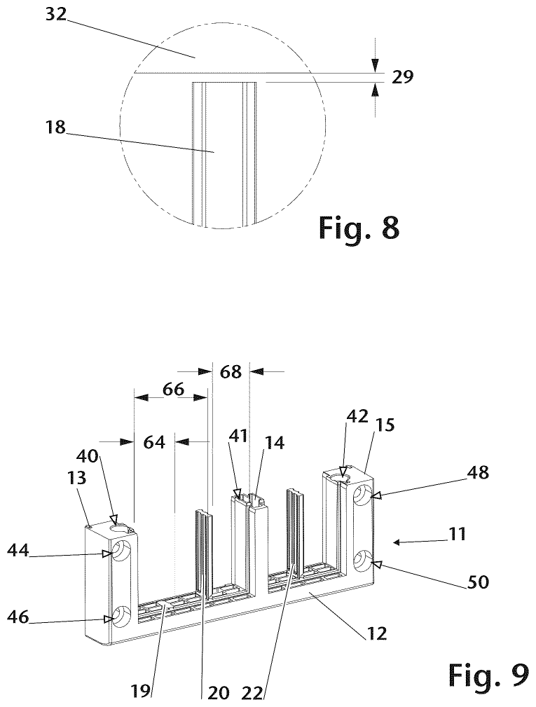

FIG. 8 shows a detail VIII from FIG. 7. The assembly aid 18 has a spacing 29 from the second frame part 32, even when the second frame part 32 is assembled on the first frame part. Due to this example, the assembly aids do not need to be threaded exactly into plug-in receptacles of the second frame part 32, so that assembly is greatly simplified.

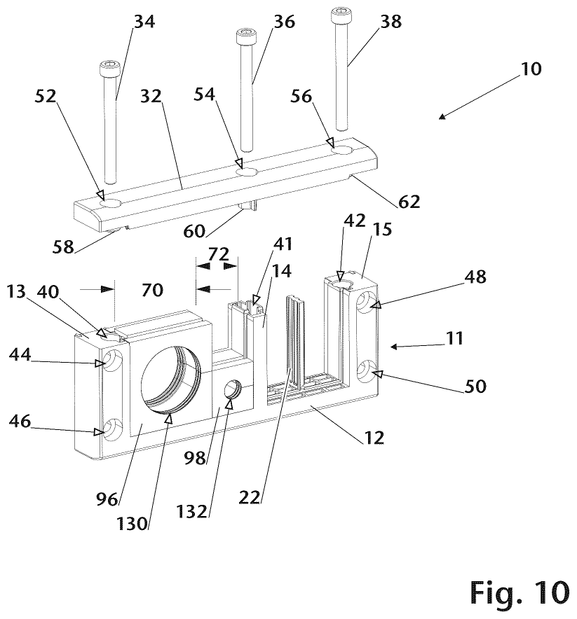

FIG. 9 shows a first frame part 11 of the conduit feed-through 10 from FIG. 7 with the assembly aid 18 removed. The break point 19 on the base web 12 is formed substantially flat and does not interfere with the assembling of, for example, the insert modules shown in FIG. 10. By removing the assembly aid 18, a first spacing 64 for an insert element between the vertical web 13 and the assembly aid 18 has been increased to a second spacing 66 between the vertical web 13 and the assembly aid 14. The first spacing 68 between the assembly aid 20 and the vertical web 14 remains unchanged. In FIG. 9, the assembly aid 22 also remains between the vertical webs 14 and 15.

The vertical webs 13, 14, and 15 comprise receivers 40, 41, and 42. Furthermore, the first frame part 11 comprises the fastening holes 44, 46, 48, and 50, which are arranged continuously in the vertical webs 13 and 15.

FIG. 10 shows the conduit feed-through 10 from FIG. 9 partially equipped with insert modules 96 and 98. An insert module 96 has a defined nominal width 70 which is provided for the second spacing 66 between the vertical web 13 and the assembly aid 20 which is visible in FIG. 9. The insert module 96 comprises an elongated part receiver 130. In addition to the insert module 96, a further insert module 98 with an elongated part receiver 132 is inserted into the first frame part 11 between the assembly aid 20 and the vertical web 14. The conduit feed-through 10 can be used partially assembled. However, it is preferably fully assembled in order to inhibit the insert modules from slipping or to seal a casing on which the conduit feed-through 10 is assembled.

A further assembly aid 22 is arranged between the vertical webs 14 and 15. A second frame part 32, which can be placed on the vertical webs 13, 14 and 15, comprises receivers 52, 54 and 56 for fastening elements 34, 36 and 38, which are formed as screws. Positioning elements 58, 60, and 62 are assigned to the receivers 52, 54, and 56, which can be inserted into receivers 40, 41, and 42 of the vertical webs 13, 14, and 15. The receivers 40, 41, 42 each comprise a non-visible internal screw thread into which the fastening elements 34, 36 and 38 can be screwed. The vertical webs 13 and 15 also comprise fastening holes 44, 46, 48, 50, by means of which the first frame part 11 or the conduit feed-through 10 can be fastened to a wall.

As an advantage, a conduit feed-through 10 can be adapted to different insert modules by means of the at least one assembly aid 18, 20, 22, which can be removed without tools.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A conduit feed-through comprising:
at least one first frame part including at least one base web and at least two vertical webs;
at least one second frame part configured to be arranged on the at least two vertical webs to form at least one circumferential frame;
a number of insert modules; and
at least one assembly aid arranged between the at least two vertical webs, the at least one assembly aid is material-connected to the at least one base web and has at least one predetermined breaking point, the at least one assembly aid is configured to be separated from and removed from the at least one first frame part at the at least one predetermined breaking point, so that insert modules of different widths are insertable into the conduit feed-through.

2. The conduit feed-through according to claim 1, wherein the at least two vertical webs are arranged on exactly one first side of the at least one base web.

3. The conduit feed-through according to claim 1, wherein the at least one predetermined breaking point has a material weakening.

4. The conduit feed-through according to claim 1, wherein the at least one predetermined breaking point is directly adjacent to the at least one base web.

5. The conduit feed-through according to claim 1, wherein the at least one assembly aid includes a guide section which directly adjoins the at least one base web.

6. The conduit feed-through according to claim 1, wherein the at least one assembly aid includes a plug-in head on a second side facing away from the at least one base web for plug-in connection to the at least one second frame part.

7. The conduit feed-through according to claim 1, wherein the at least one assembly aid is arranged spaced apart from the at least one second frame part.

8. The conduit feed-through according to claim 1, wherein each insert module of the number of insert modules includes a number of elongated part receivers.

9. A use of the conduit feed-through according to claim 1 for passing cables through a wall.

10. A method for assembling a conduit feed-through according to claim 1, the method comprising:
providing the first frame part, the second frame part and the number of insert modules;
inserting at least one insert module between two vertical webs of the first frame part or between one of the two vertical webs and one assembly aid of the first frame part or between two assembly aids of the first frame part, wherein at least one assembly aid from the first frame part in advance at a pre-determined breaking point based on a spacing between a vertical web and the assembly aid or a spacing between two assembly aids being smaller than a nominal width of one of the number of insert modules; and
arranging the second frame part on the two vertical webs of the first frame part.
